(19) United States
(12) Patent Application Publication
(10) Pub. No.: US 2020/0274304 A1
(43) Pub. Date: Aug. 27, 2020

(54) CONNECTOR

(71) Applicant: Sumitomo Wiring Systems, Ltd., Yokkaichi (JP)

(72) Inventors: Ryotaro Kosaka, Yokkaichi-shi (JP); Sho Saito, Yokkaichi-shi (JP); Yujiro Imai, Yokkaichi-shi (JP)

(21) Appl. No.: 16/800,074

(22) Filed: Feb. 25, 2020

(30) Foreign Application Priority Data
Feb. 27, 2019 (JP) 2019-034218

(51) Int. Cl. H01R 13/74; H01R 13/52

(52) U.S. Cl. CPC H01R 13/74; H01R 13/5202

(57) ABSTRACT

A connector includes a housing to be disposed on a panel, a lock portion projecting forward of the housing, and an opening open rearward of the housing. The lock portion is hooked to a front surface side of the panel to restrict separation from the panel. The opening is arranged at a position facing the lock portion in the housing.

### BACKGROUND

### Field of the Invention

This disclosure relates to a connector.

### Related Art

Japanese Unexamined Patent Publication No. 2002-151199 discloses a connector with a male housing to be disposed on a panel while being passed through a mounting hole of the panel. A movable lock projects forward on the male housing and includes a claw to be hooked to a front surface of the panel. Hooked engagement of the movable lock to the front surface of the panel prevents separation of the male housing from the panel. A rear side of the claw is covered by a flange of the male housing. Japanese Unexamined Patent Publication No. H10-233262 and Japanese Unexamined Patent Publication No. 2018-133130 also describe a connector to be mounted on a panel.

The male housing of Japanese Unexamined Patent Publication No. 2002-151199 is removed from the panel by bringing a tool into contact with the claw and deflecting the movable locking claw down. The claw is located on the front surface of the panel and the rear side thereof is covered by the flange. Thus, a worker cannot bring the tool into contact with the claw portion from a rear surface side of the panel. However, it may be requested to remove the male housing from the rear surface side of the panel due to a working situation or the like.

Accordingly, it is aimed to provide a connector with excellent work efficiency when being removed from a panel.

### SUMMARY

This disclosure is directed to a connector with a housing to be disposed on a panel, a lock projecting forward of the housing, and an opening open rearward of the housing. The lock is hooked to a front surface side of the panel to restrict separation from the panel. The opening is at a position facing the lock in the housing. A worker can insert a tool, a finger or the like into the opening from a rear surface side of the panel to remove the connector from the panel. The worker then can bring the tool, the finger or the like into contact with the lock through the opening and release the locked state of the lock to the panel. Thus, the worker can release the lock either from the front surface side or from the rear surface side.

A closing member may be attachable to and detachable from the housing and may be configured to close the opening. The opening can be closed by the closing member except while the lock is being released. The closing of the opening by the closing member prevents external matter, such as dust and dirt, from entering the housing,

The closing member may include a seal to be held in close contact with an inner surface of the opening. The opening is made watertight by holding the seal of the closing member in close contact with the inner surface of the opening.

At least one of a recess and a protrusion may be provided on a rear surface of the closing member. In releasing the lock, the worker can remove the closing member from the opening by placing his/her finger, a tool or the like into contact with at least one of the recess and the protrusion.

The lock may be separate from the housing, and the housing may include an accommodating portion for accommodating the lock. The accommodating portion may be open forward of the housing and may communicate with the opening. Thus, the accommodating portion and the opening may communicate with each other and may penetrate through the housing in a front-rear direction. Accordingly, the accommodating portion and the opening can be molded easily by a mold movable in the front-rear direction. Further, a structure for fixing the lock easily can be formed in the accommodating portion

According to this disclosure, it is possible to provide a connector that can be removed efficiently from a panel.

### BRIEF DESCRIPTION OF DRAWINGS

FIG. 1 is a section showing a state where a connector according to an embodiment is mounted on a panel.

FIG. 2 is a section showing a state in the process of mounting the connector according to the embodiment on the panel.

FIG. 3 is an enlarged section of a part where a sealing ring, a lock portion and a closing member are mounted in a housing.

FIG. 4 is a front view of a mounting portion on a flange portion of the housing.

FIG. 5 is a back view of the mounting portion on the flange portion of the housing.

FIG. 6 is a perspective view of the lock portion.

FIG. 7 is a perspective view of the closing member.

FIG. 8 is a back view showing a state where an opening of the mounting portion on the flange portion of the housing is closed by the closing member.

FIG. 9 is a section showing a state where a tool is inserted into the opening from a state shown in FIG. 3 to release a hooked state of the lock portion.

### DETAILED DESCRIPTION

An example of the disclosure is described below with reference to the drawings. Note that the invention is not limited to these illustrations and is intended to be represented by claims and include all changes in the scope of claims and in the meaning and scope of equivalents.

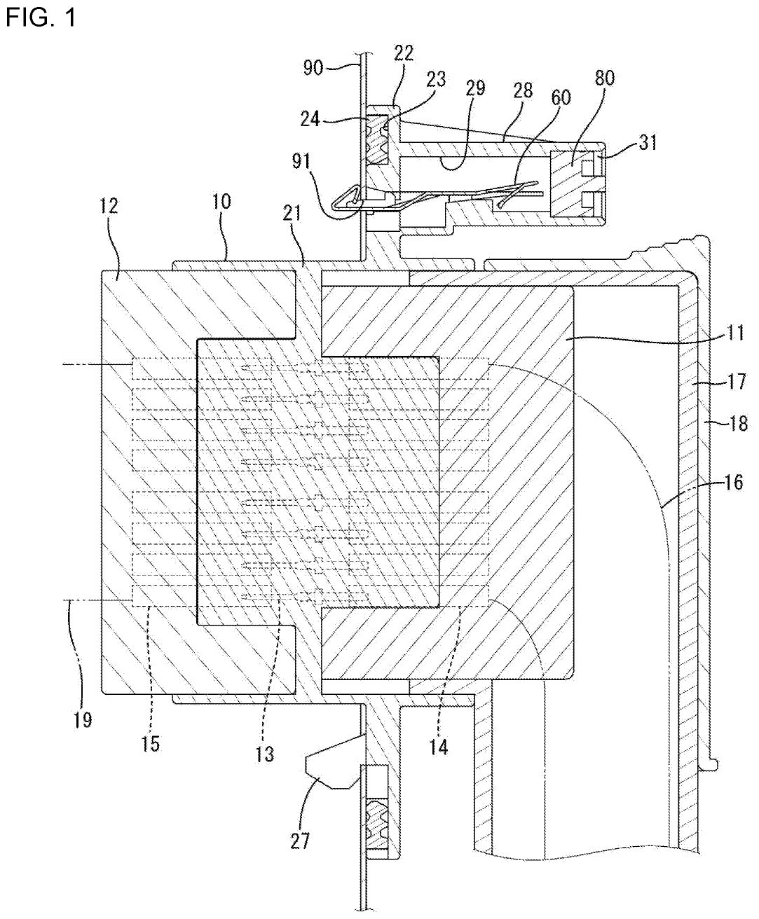

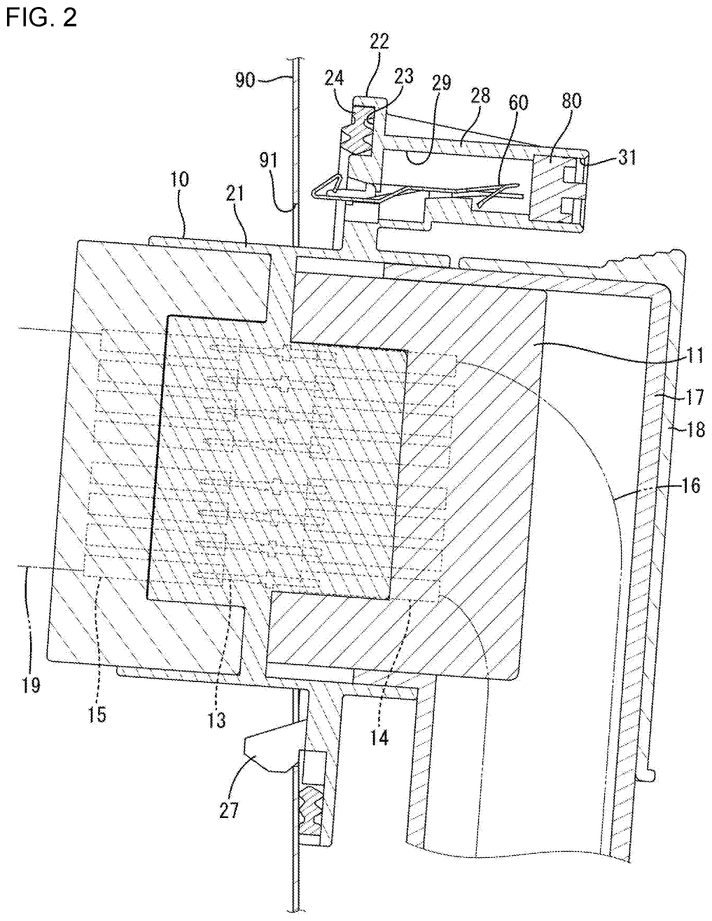

A connector according to an embodiment is a panel mount type connector to be mounted on a panel 90. In this embodiment, the panel is a door panel of an unillustrated automotive vehicle. For example, a front surface (left side of FIGS. 1 and 2) of the panel 90 is a vehicle body side, and a rear surface (right side of FIGS. 1 and 2) of the panel 90 is a door side. The connector includes an intermediate housing 10 made of synthetic resin. A lock 60 made of metal and a closing member 80 made of rubber are mounted in the intermediate housing 10.

### <Overall Structure of Connector>

As shown in FIGS. 1 and 2, the intermediate housing 10 is configured as a relay housing and is disposed through a mounting hole 91 of a panel 90. The intermediate housing 10 includes first and second housings 11 and 12 that are made of synthetic resin and that are connected respectively to opposite front and rear ends of the intermediate housing 10.

Tab-like terminal fittings 13 are mounted in the intermediate housing 10. Each terminal fitting 13 includes a rearward projecting part that is connected electrically to a first terminal 14 accommodated into the first housing 11 and forward projecting part that is connected electrically to a second terminal 15 accommodated into the second housing 11.

Each first terminal 14 is connected to an end part of a first wire 16 that is pulled out from the rear surface of the first housing 11. A grommet 17 made of rubber is mounted on a rear part of the first housing 11 and is configured so that each first wire 16 is surrounded and bent down by the grommet 17. A grommet cover 18 made of synthetic resin is mounted on a rear part of the first housing 11 for covering the grommet 17. Each second terminal 15 is connected to an end part of a second wire 19 that is pulled out from the front surface of the second housing 12.

### <Detailed Structure of Housing 10 and Sealing Structure for Panel 90>

As shown in FIGS. 1 and 2, the intermediate housing 10 includes a housing body 21 to which the first and second housings 11, 12 are connected, and a flange 22 protrudes toward an outer peripheral side of the housing body 21 over the entire periphery. The housing body 21 is arranged through the mounting hole 91 of the panel 90. The flange 22 is arranged to face an opening edge part of the mounting hole 91 on the rear surface of the panel 90. A mounting groove 23 is recessed over the entire periphery in the front surface of the flange 22.

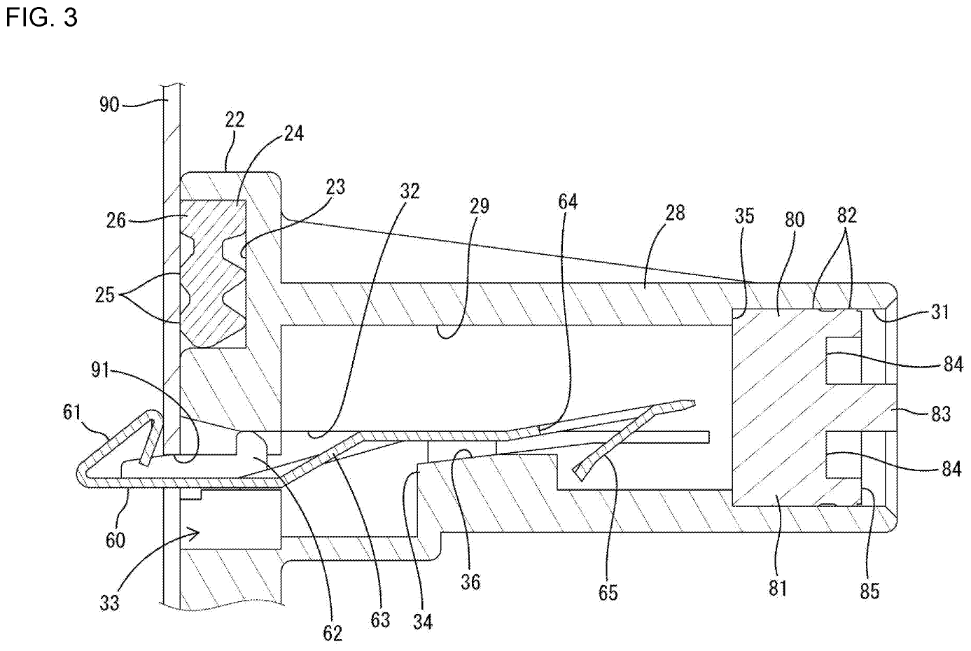

An annular sealing ring 24 is accommodated in the mounting groove 23 of the flange 22. The sealing ring 24 is made of rubber, such as silicon rubber, and includes inner and outer sealing lips 25 on an outer periphery of each of front and rear surfaces as shown in FIG. 3. Each sealing lip 25 has an arcuate cross-sectional shape. The sealing ring 24 includes one inner pressure lip 26 and one outer pressure lip 26 on outer peripheral sides of the front and rear surfaces. Each pressure lip 26 has a rectangular or trapezoidal cross-sectional shape. A projecting dimension of the pressure lip 26 in the front-rear direction is smaller than that of the sealing lip 25.

The sealing ring 24 is sandwiched between the rear surface of the panel 90 and the back surface of the mounting groove 23. A front part of each sealing lip 25 is squeezed into close contact with the rear surface of the panel 90. A rear part of each sealing lip 25 is squeezed into contact with the back surface of the mounting groove 23. A front part of the pressure lip 26 can face and contact the rear surface of the panel 90, but is not squeezed. A rear part of the pressure lip 26 can face and contact the back surface of the mounting groove 23, but is not squeezed. Further, an outer peripheral part of the pressure lip 26 can face and contact the outer peripheral surface of the mounting groove 23, but is not squeezed.

Each sealing lip 25 is squeezed into close contact with the flange 22 and the panel 90, thereby waterproofing a gap between the connector and the panel 90. Further, the pressure lips 26 fill up a clearance between the flange 22 and the panel 90 to prevent intrusion of high-pressure washing water to an inner peripheral side of the sealing ring 24. Thus, reliable waterproof performance by the sealing ring 24 is achieved.

As shown in FIGS. 1 and 2, the housing 10 includes an arm 27 below the flange 22 and on an inner peripheral side of the mounting groove 23. The arm 27 is inserted into the mounting hole 91 of the panel 90 from behind.

As shown in FIG. 3, a mounting portion 28 is formed on an upper part of the flange 22 of the housing 10 and receives the lock 60 and the closing member 80. The mounting portion 28 projects rearward of the flange 22 at a position outward peripheral sides of the grommet 17 and the grommet cover 18 and on an inner peripheral side of the mounting groove 23. An accommodating portion 29 is open forward in a front part of the mounting portion 28 and an opening 31 is open rearward in a rear part of the mounting portion 28. A dimension of the accommodating portion 29 in the front-rear direction is larger than that of the opening 31 in the front-rear direction. The mounting portion 28 includes a step 35 between the accommodating portion 29 and the opening 31. As shown in FIG. 5, the opening 31 has a circular cross-sectional shape and has a larger opening diameter than the accommodating portion 29 via the step 35.

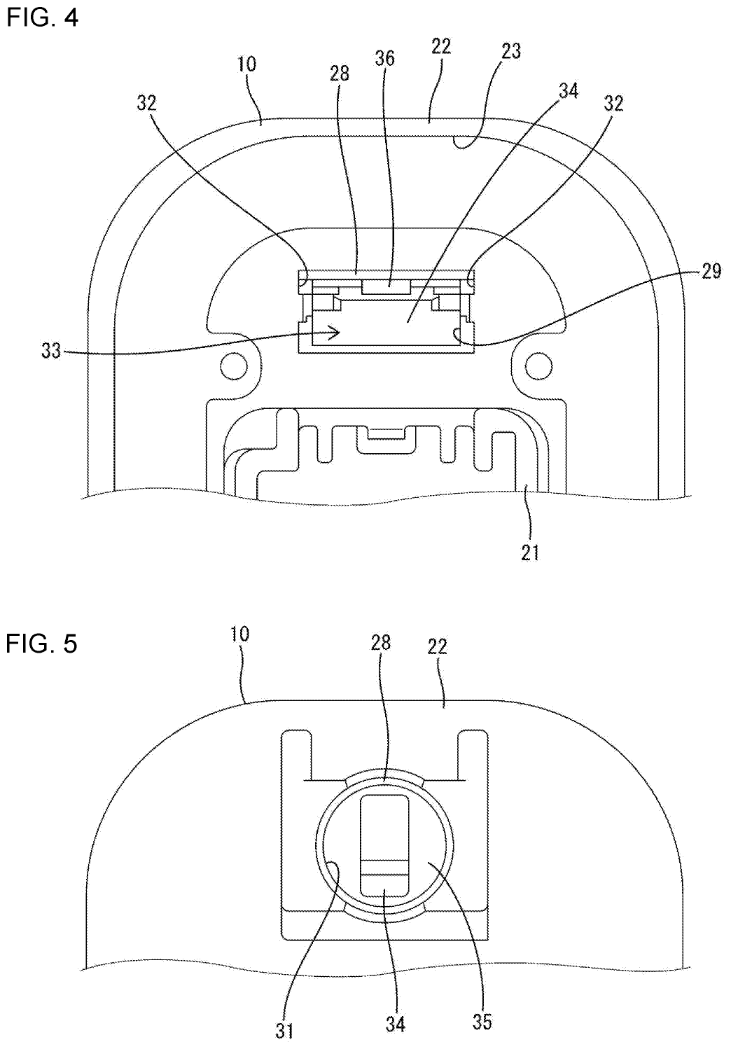

As shown in FIG. 4, the accommodating portion 29 includes an insertion groove 32 in the form of a slit elongated in a width direction and a deflection space 33 having a rectangular cross-sectional shape long in the width direction below the insertion groove 32. Further, as shown in FIG. 3, the accommodating portion 29 includes a trapezoidal stop 34 below the insertion groove 32 and behind the deflection space 33. An upwardly inclined slope 36 is provided on a front side of the upper surface of the stop 34. The rear surface of the stop 34is vertical and faces the opening 31. Note that the rear surface of the stop 34 and the step 35 are formed by an unillustrated mold removed rearward.

### <Lock 60>

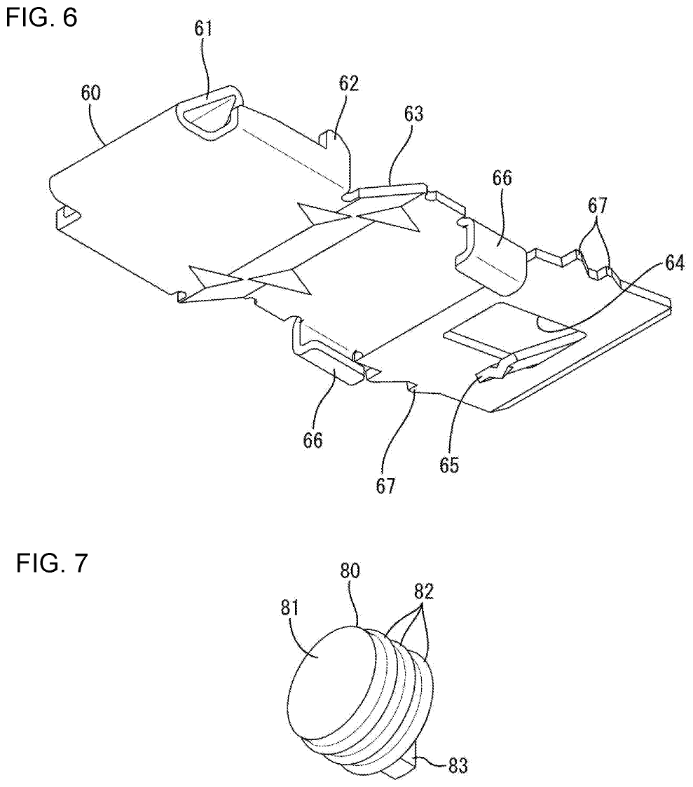

The lock 60 is separate from the housing 10 and mounted into the mounting portion 28 from the front. The lock 60 is formed, such as by bending a metal plate. As shown in FIGS. 3 and 6, a hook 61 is provided on a front part of the lock 60 and is bent to have a chevron shape in a side view. Contacts 62 having a rectangular shape in a side view rise on both left and right sides (only one side is shown) across the hook 61.

An intermediate part of the lock 60 in the front-rear direction has an inclined portion 63 inclined up from a front end toward a rear end. As shown in FIG. 6, U-shaped inserting portions 66 and claw-shaped projections 67 protrude toward both left and right sides in parts near the inclined portion 63 in a rear part of the lock 60.

A rectangular cutout 64 is formed in the rear part of the lock 60 at a position overlapping the projections 67 in the front-rear direction. A rectangular plate-shaped stopper 65 projects obliquely forward and down in the cutout 64 and in the rear part of the lock 60.

### <Closing Member 80>

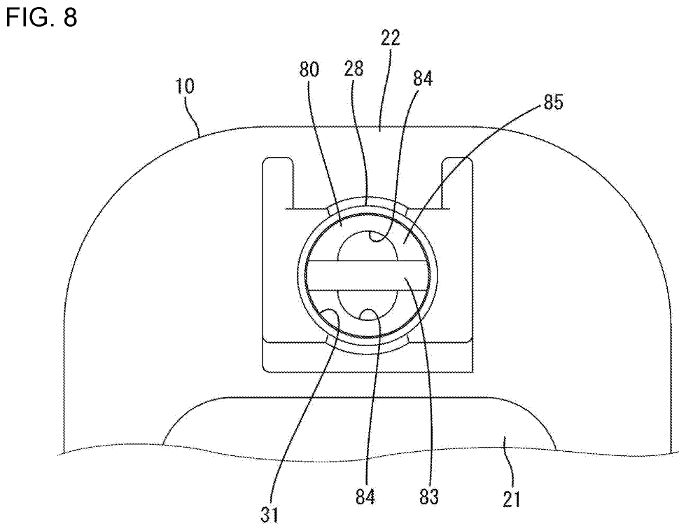

As shown in FIG. 7, the closing member 80 includes a cylindrical body 81 with an outer diameter equal to or smaller than that of the opening 31. A dimension of the body 81 in the front-rear direction is smaller than that of the opening 31 in the front-rear direction. Sealing portions 82 are provided on the outer peripheral surface of the closing member 80. In particular, three sealing portions 82 in the form of lips extend in a circumferential direction of the body 81 and are arranged one after another in the front-rear direction. As shown in FIG. 8, a rib-like protrusion 83 extends in the width direction (radial direction) on the rear surface of the body 81. The protrusion 83 is provided in a diameter direction of the body 81. Further, recesses 84 are provided in a central part (inner peripheral part) of the rear surface of the body 81. The recesses 84 have semicircular shapes and are arranged on both upper and lower sides across the protrusion 83. As shown in FIG. 3, an outer peripheral portion 85 on the rear surface of the body 81 is located behind the back surfaces of the recesses 84 and in front of the rear surface of the protrusion 83.

<Mounting Structure of Lock 60 into Housing 10>

The lock 60 is inserted into the accommodating portion 29 from the front. The inserting portions 66 are press-fit and inserted into the insertion groove 32. With the inserting portions 66 inserted in the insertion groove 32, the stopper 65 slides in contact with the slope 36 of the stop 34 and is deflected and deformed. The stop 65 separates from the upper surface of the stopping portion 34 and returns to an original state when the inserting portions 66 are inserted to a proper depth into the insertion groove 32. As shown in FIG. 3, the tip (front end) of the stop 65 can face and contact the rear surface of the stopping portion 34. In this way, the lock 60 is fixed while being retained in the accommodating portion 29. The hook 61 of the lock 60 projects farther forward than the flange 22. Further, the projections 67 bite into the inner wall of the accommodating portion 29 to maintain a mounted state of the lock 60.

<Mounting Structure of Closing Member 80 into Housing 10>

The closing member 80 is inserted into the mounting portion 28 from behind the opening 31. When the closing member 80 is inserted to a proper depth into the opening 31, the front end of the body 81 contacts the step 35, as shown in FIG. 3, to stop the insertion of the closing member 80. Each sealing portion 82 is held in close contact with the inner peripheral surface of the opening 31 to be squeezed. In this way, the mounting portion 28 is waterproofed and water cannot intrude into the accommodating portion 29. The outer peripheral portion 85 on the rear surface of the body 81 is arranged in the opening 31. The rear surface of the protrusion 83 is arranged at the same position as the rear end of the opening 31 or arranged to project rearward from the opening 31. Note that a mounting procedure of the closing member 80 and the lock 60 into the housing 10 can vary. The lock 60 may be mounted after the closing member 80 is mounted or the closing member 80 may be mounted after the lock 60 is mounted.

### <Mounting Structure of Connector on Panel 90>

The connector is arranged on the rear side of the panel 90 with the front surface of the housing 10 facing obliquely up. Subsequently, the connector is inserted into the mounting hole 91 of the panel 90 from behind. As shown in FIG. 2, a front part of the arm 27 is hooked to a lower opening edge of the mounting hole 91 on the front surface of the panel 90. As shown in FIGS. 2 and 1, the connector is rotated forward with a position where the front part of the arm 27 is hooked to the panel 90 as a support. In a rotation process of the connector, an inclined part of the front surface of the hook 61 of the lock 60 slides in contact with an upper surface of the mounting hole 91. The front part of the lock 60 is deflected and deformed into the deflection space 33 with the inserting portions 66 mounted in the insertion groove 32 as supports. When the connector reaches a vertical posture, as shown in FIG. 1, the lock 60 returns to the original state and the hooking 61 is hooked to an upper opening edge of the mounting hole 91 on the front surface of the panel 90. In this way, the connector is mounted on the panel 90. As shown in FIG. 3, the contact portions 62 are positioned in contact with the hole surface of the mounting hole 91 of the panel 90.

The sealing ring 24 is arranged in a liquid-tight manner by being sandwiched between the panel 90 and the flange 22. The mounting portion 28 is waterproofed by the closing member 80. Thus, water cannot intrude into the housing 10 from the rear of the panel 90.

### <Connector Removing Operation>

In removing the connector from the rear side of the panel 90, the closing member 80 is first pulled out from the opening 31. At this time, worker's fingers or a tool (not shown) are placed on the protrusion 83 and the recesses 84. For example, the closing member 80 is pulled out with the protrusion 83 held by the worker's fingers and the finger tips inserted in the recesses 84. Note that the worker's fingers or the tool are placed on the protrusion 83 and the recesses 84 also in mounting the closing member 80 into the opening 31. By opening the opening 31, the lock 60 faces the rear surface of the panel 90 through the opening 31.

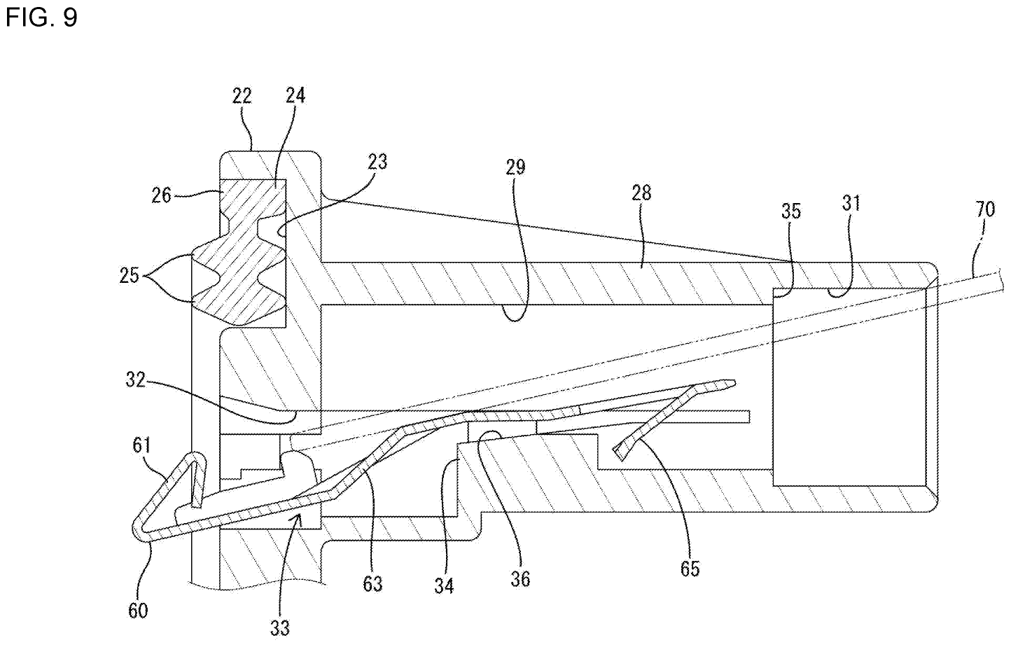

Subsequently, as shown in FIG. 9, a rod-like tool 70 is inserted into the opening 31 from behind. A tip part of the tool 70 is inserted into the accommodating portion 29 from the opening 31 and brought into contact with the contact portions 62 of the lock 60 from behind. The hook 61 is pressed by the tool 70 and displaced down, thereby releasing a state hooked to the panel 90. In that state, the connector is tilted rearward with the position where the front part of the arm 27 is hooked to the panel 90 as a support. Thereafter, the connector is pulled apart from the panel 90.

In removing the connector from the front side of the panel 90, the tool 70 is brought directly into contact with the hooking 61 facing the front surface of the panel 90. The hook 61 is displaced down by being pressed by the tool 70 to release the state hooked to the panel 90. Thereafter, the connector is tilted rearward and pulled apart from the panel 90 in the same manner as above.

According to this embodiment, the worker can remove the connector from the panel 90 not only from the front of the panel 90, but also from the rear of the panel 90. The lock 60 can be unhooked from the panel 90 through the opening 31 from the rear of the panel 90. The opening 31 is kept closed by the closing member 80 except during the connector removing operation. Thus, external matter, such dust and dirt cannot enter the opening 31. Further, the opening 31 is waterproofed by the sealing portions 82 of the closing member 80.

The embodiment disclosed should be considered to be illustrative in all aspects, rather than restrictive. The scope of the invention is not limited to the above contents and is intended to be represented by claims and include all changes in the scope of claims and in the meaning and scope of equivalents.

Although the opening 31 is closed by the closing member 80 in the above embodiment, the opening 31 may be constantly open as another embodiment.

Although the protrusion 83 and the recesses 84 are provided on the rear surface of the closing member 80 in the above embodiment, the protrusion 83 and the recesses 84 may not be provided on the rear surface of the closing member 80 as another embodiment. Further, only either the protrusion 83 or the recesses 84 may be provided on the rear surface of the closing member 80.

Although the closing member 80 includes the sealing portions 82 in the above embodiment, the closing member 80 may be configured as a plug member having no sealing performance as another embodiment.

Although the lock 60 is made of metal and separate from the housing 10 in the above embodiment, the lock 60 may be made of resin and integrated with the housing 10 as another embodiment.

### LIST OF REFERENCE SIGNS

10 . . . housing
11 . . . first housing
12 . . . second housing
13 . . . terminal fitting
14 . . . first terminal
15 . . . second terminal
16 . . . first wire
17 . . . grommet
18 . . . grommet cover
19 . . . second wire
21 . . . housing body
22 . . . flange
23 . . . mounting portion
24 . . . sealing ring
25 . . . sealing lip
26 . . . pressure lip
27 . . . arm
28 . . . mounting portion
29 . . . accommodating portion
31 . . . opening
32 . . . insertion groove
33 . . . deflection space
34 . . . stopping portion
35 . . . step
36 . . . slope
60 . . . lock
61 . . . hook
62 . . . contact portion
63 . . . inclined portion
64 . . . cutout
65 . . . stopper
66 . . . inserting portion
67 . . . projection
70 . . . tool
80 . . . closing member
81 . . . body
82 . . . sealing portion
83 . . . protrusion
84 . . . recess
85 . . . outer peripheral portion
90 . . . panel
91 . . . mounting hole

What is claimed is:

1. A connector, comprising:
a housing (10) to be disposed on a panel (90);
a lock (60) projecting forward of the housing (10); and
an opening (31) open rearward of the housing (10),
wherein:
the lock (60) is hooked to a front surface of the panel (90) to restrict separation from the panel (90), and
the opening (31) is arranged at a position facing the lock (60) in the housing.

2. The connector of claim 1, comprising a closing member (80) attachable to and detachable from the housing (10), the closing member (80) closing the opening (31).

3. The connector of claim 2, wherein the closing member (80) includes a sealing portion to be held in close contact with an inner surface of the opening (80).

4. The connector of claim 3, wherein at least one of a recess and a protrusion is provided on a rear surface of the closing member (80).

5. The connector of claim 4, wherein the lock (60) is separate from the housing (10), the housing (10) includes an accommodating portion (28) for accommodating the lock (60) and the accommodating portion (28) is open forward of the housing (10) and communicates with the opening (80).
